(19) United States
(12) Patent Application Publication
(10) Pub. No.: US 2022/0353428 A1
(43) Pub. Date: Nov. 3, 2022

(54) IMAGE PICKUP APPARATUS, LENS APPARATUS, CONTROL METHOD AND APPARATUS, AND STORAGE MEDIUM

(71) Applicant: CANON KABUSHIKI KAISHA, Tokyo (JP)

(72) Inventors: Yasuhiro Hatakeyama, Tochigi (JP); Kazuya Higuma, Saitama (JP); Gaku Takahashi, Tochigi (JP)

(21) Appl. No.: 17/730,422

(22) Filed: Apr. 27, 2022

(30) Foreign Application Priority Data
Apr. 30, 2021 (JP) 2021-076984

(51) Int. Cl. H04N 5/232; H04N 5/225

(52) U.S. Cl. CPC H04N 5/232127; H04N 5/2254; H04N 5/23245; H04N 5/23203

(57) ABSTRACT

An image pickup apparatus attachable to and detachable from a lens apparatus includes an image sensor, an acquiring unit configured to acquire a hyperfocal length of the lens apparatus, and a setting unit configured to enable a user to change a diameter of a permissible circle of confusion for acquiring the hyperfocal length.

### BACKGROUND OF THE INVENTION

### Field of the Invention

The present invention relates to a lens interchangeable type image pickup apparatus and a lens apparatus.

### Description of the Related Art

Deep focus imaging is one imaging method in which a depth of field is deepened to capture images while a range from a short distance to infinity is maintained in an in-focus state. A user can set deep focus by calculating a hyperfocal length (hyperfocal distance) based on a nominal focal length of a lens, the number of pixels on an image sensor, and a set aperture value (set F-number), and by manually moving a focus lens to a lens position corresponding to the hyperfocal length. However, this deep focus setting requires the user for special knowledge and skill.

Japanese Patent Laid-Open No. (“JP”) 2006-227133 discloses a lens integrated type image pickup apparatus that automatically performs deep focus imaging as a countermeasure to autofocus (“AF”) failure in which an object cannot be focused by AF. JP 2003-140025 discloses a lens integrated type image pickup apparatus that enables a normal imaging mode that provides AF and a snapshot mode that provides deep focus imaging to be selected.

The lens integrated type image pickup apparatuses disclosed in JPs 2006-227133 and 2003-140025 can automatically set deep focus in deep focus imaging. However, each of JPs 2006-227133 and 2003-140025 is silent about automatic deep focus setting in a lens interchangeable type image pickup system in which a variety of types of interchangeable lenses are attachable to an image pickup apparatus.

A focus accuracy and a focusable distance range (focus range) required by the user in deep focus imaging differ depending on an application of a captured image and do not depend only on the specifications and performances of the image pickup apparatus and lens. However, each of JPs 2006-227133 and 2003-140025 is silent about a method that provides deep focus imaging suitable for the focus accuracy and focus range required by the user.

### SUMMARY OF THE INVENTION

The present invention provides an image pickup apparatus, a lens apparatus, a control method and apparatus, and a storage medium for an interchangeable lens image pickup system, each of which can easily provide deep focus imaging with a focus range and focus accuracy requested by a user.

An image pickup apparatus according to one aspect of the present invention is attachable to and detachable from a lens apparatus. The image pickup apparatus includes an image sensor, at least one processor, and at least one memory coupled to the at least one processor storing instructions that, when executed by the at least one processor, cause the at least one processor to function as an acquiring unit configured to acquire a hyperfocal length of the lens apparatus, and a setting unit configured to enable a user to change a diameter of a permissible circle of confusion for acquiring the hyperfocal length.

A lens apparatus according to another aspect of the present invention attachable to, detachable from, and communicable with the above image pickup apparatus includes a focus lens, and a lens control unit configured to drive the focus lens to a position corresponding to a hyperfocal length. A control method according to another aspect of the present invention of an image pickup apparatus attachable to and detachable from a lens apparatus and including an image sensor includes the steps of acquiring a hyperfocal length of the lens apparatus, and accepting a change by a user of a diameter of a permissible circle of confusion for acquiring the hyperfocal length. A non-transitory computer-readable storage medium storing a program that causes a computer of an image pickup apparatus that includes an image sensor and is attachable to and detachable from a lens apparatus, to execute the above control method also constitutes another aspect of the present invention.

A control apparatus according to another aspect of the present invention includes at least one processor, and at least one memory coupled to the at least one processor storing instructions that, when executed by the at least one processor, cause the at least one processor to function as an acquiring unit configured to acquire a hyperfocal length of a lens apparatus attachable to and detachable from an image pickup apparatus, and a setting unit configured to enable a user to change a diameter of a permissible circle of confusion for acquiring the hyperfocal length.

A control apparatus for an image pickup apparatus according to another aspect of the present invention includes at least one processor, and at least one memory coupled to the at least one processor storing instructions that, when executed by the at least one processor, cause the at least one processor to function as a selecting unit configured to enable a user to select a viewing condition of an image, and a calculating unit configured to calculate a hyperfocal length of an imaging optical system.

Further features of the present invention will become apparent from the following description of exemplary embodiments with reference to the attached drawings.

### BRIEF DESCRIPTION OF THE DRAWINGS

FIG. 1 is a block diagram illustrating a configuration of a lens interchangeable type image pickup system according to one embodiment of the present invention.

FIG. 2 illustrates flowcharts of processing to be executed in this embodiment.

FIG. 3 illustrates an operation screen for selecting a diameter of a permissible circle of confusion (“PCOC”) according to a first embodiment.

FIG. 4 illustrates an operation screen for selecting a diameter of PCOC according to a second embodiment.

FIG. 5 illustrates an operation screen for selecting a diameter of PCOC according to a third embodiment.

### DESCRIPTION OF THE EMBODIMENTS

Referring now to the accompanying drawings, a description will be given of embodiments according to the present invention.

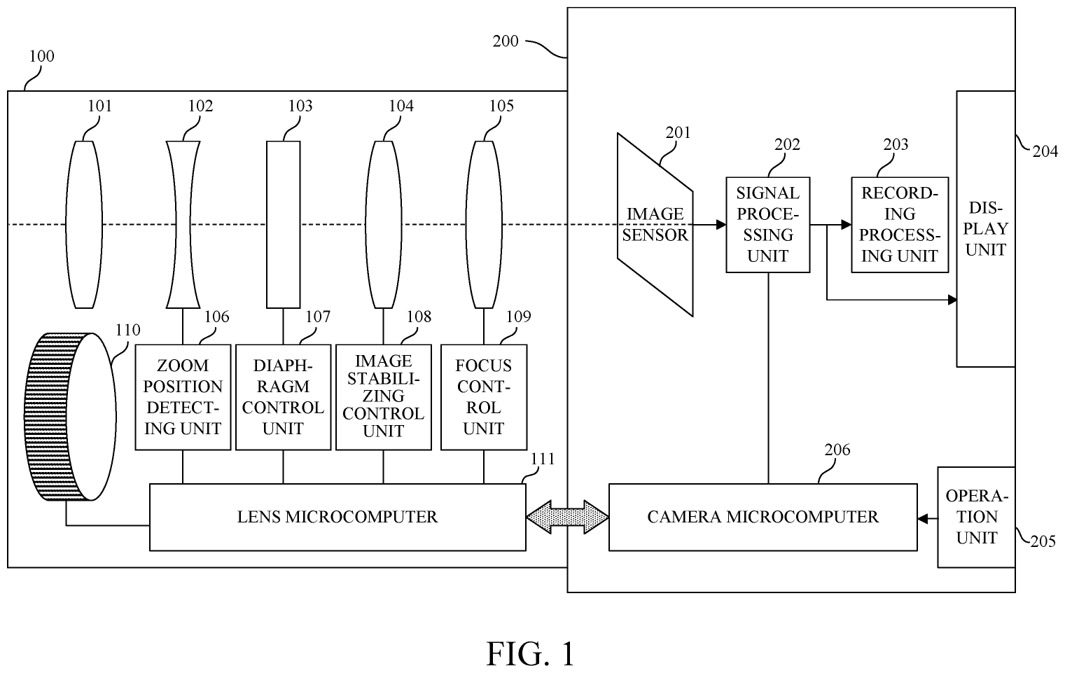

FIG. 1 illustrates a configuration of a lens interchangeable type image pickup system according to one embodiment of the present invention. The image pickup system includes a camera body 200 as an image pickup apparatus and an interchangeable lens 100 as a lens apparatus attachable to, detachable from, and communicable with the camera body 200.

The interchangeable lens 100 is mechanically and electrically connected to the camera body 200 via an unillustrated mount. The interchangeable lens 100 includes an imaging lens as an imaging optical system and a lens microcomputer 111, and operates by receiving a power supply from the camera body 200 via an unillustrated power supply terminal provided on the mount.

The camera body 200 includes an image sensor 201 including phase difference focus detecting pixels and the like, a signal processing circuit 202, a recording processing unit 203, a display unit 204, an operation unit 205, and a camera microcomputer 206.

The image sensor 201 performs a photoelectric conversion (imaging) of an object image formed by the imaging lens and outputs an analog imaging signal as an electric signal. The analog imaging signal is converted into a digital imaging signal by an unillustrated A/D conversion circuit.

The signal processing circuit 202 generates a video signal (captured image) by performing various image processing for the digital imaging signal. The signal processing circuit 202 also generates focus information indicating a contrast state of the object image, that is, a focus state of the imaging lens, and luminance information indicating an exposure state from the video signal.

The display unit 204 is a rear monitor or an electronic viewfinder, and displays a live-view image corresponding to the video signal from the signal processing circuit 202 so as to enable the user to confirm the object and composition. The recording processing unit 203 stores the video signal from the signal processing circuit 202 as still image data or moving (motion) image data in an unillustrated recording medium.

The camera microcomputer 206 as a camera control unit and an acquiring unit controls the camera body 200 in response to an input from an imaging instruction switch and various setting switches included in the operation unit 205. The operation unit 205 further includes a switch (deep focus setting switch) for commanding a deep focus setting described below. The deep focus setting switch may be a dedicated switch or a function assignable switch to which a function of a deep focus setting switch is assigned by the user by a customizing function.

The camera microcomputer 206 communicates with the lens microcomputer 111 via the communication terminal provided on the mount. More specifically, the camera microcomputer 206 transmits to the lens microcomputer 111 a diaphragm control command according to the luminance information and a focus control command according to the focus information generated from the output of the phase difference detecting pixels of the image sensor 201. The lens microcomputer 111 transmits information for use with deep focus control, which will be described below, to the camera microcomputer 206.

The imaging lens included in the interchangeable lens 100 includes a field lens 101, a magnification-varying (zoom) lens 102, a diaphragm (aperture stop) unit 103, an image stabilizing lens 104, and a focus lens 105. The interchangeable lens 100 includes an unillustrated zoom operation ring, a focus operation ring 110, and the lens microcomputer 111 described above.

The lens microcomputer 111 transmits lens data including identification (ID) information and optical information on the interchangeable lens 100 to the camera body 200 in response to a transmission request transmitted from the camera body 200 (camera microcomputer 206). The lens microcomputer 111 receives the camera data including various information on the camera body 200 from the camera body 200 in response to a reception request transmitted from the camera body 200.

The lens microcomputer 111 causes a diaphragm control unit 107 to open and close the diaphragm unit 103 in response to the diaphragm control command received from the camera body 200. Positions of diaphragm blades of the diaphragm unit 103 are detected by a sensor such as a Hall element, and diaphragm position data is output to the lens microcomputer 111. The diaphragm control unit 107 that has received a driving command from the lens microcomputer 111 drives the diaphragm blades to open and close by driving a diaphragm actuator that includes a stepping motor, a voice coil motor, or the like. Thereby, a light amount is adjusted by the diaphragm unit 103.

The lens microcomputer 111 causes the focus control unit 109 to drive the focus lens 105 in an optical axis direction in response to the focus control command received from the camera body 200. The position of the focus lens 105 is detected with a sensor such as a photo-interrupter, and the focus position data is output to the lens microcomputer 111. The lens microcomputer 111 calculates a target position of the focus lens 105 based on the focus position data and the focus driving amount data included in the focus control command. The focus control unit 109 that has received the driving command including the target position from the lens microcomputer 111 drives a focus actuator such as a stepping motor to move the focus lens 105. Thereby, autofocus (AF) is performed. A lens control unit includes the lens microcomputer 111 and the focus control unit 109.

The lens microcomputer 111 can also cause the focus control unit 109 to move the focus lens 105 according to an operation amount of the focus operation ring 110. Thereby, manual focus (MF) is performed.

The zoom lens 102 is driven in the optical axis direction via an unillustrated driving mechanism when the user operates the zoom operation ring. Thereby, a magnification variation that changes a focal length of the imaging lens is performed. A zoom position detecting unit 106 detects the position (zoom position) of the zoom lens 102 using a sensor such as a variable resistor, and outputs the zoom position data to the lens microcomputer 111. The lens microcomputer 111 uses the zoom position data to generate information on the focal length.

The image stabilizing lens 104 reduces (corrects) an image blur caused by camera shake or the like by moving (shifting) in a direction having a component orthogonal to the optical axis of the imaging lens. An image stabilizing control unit 108 that has received an image stabilizing command from the lens microcomputer 111 drives an image stabilizing actuator including a voice coil motor or the like in response to the shake detected by a vibration sensor such as an unillustrated vibration gyro so as to shift the image stabilizing lens 104. Thereby, optical vibration isolation is performed.

A description will now be given of deep focus control according to this embodiment. The camera microcomputer 206 starts the deep focus control by detecting that the operation unit 205 (deep focus setting switch) has been operated by the user. For example, the camera microcomputer 206 calculates a hyperfocal length using the focal length of the imaging lens received from the lens microcomputer 111, and transmits the deep focus drive command to the lens microcomputer 111 together with the hyperfocal length.

The hyperfocal length is the closest distance so that infinity is included in the depth of field, and can be calculated by the following equation (1):

h=f²/(Fδ) (1)
h: Hyperfocal length [mm]
F: Aperture value (F-number)
f: Focal length of the imaging lens [mm]
δ: Diameter of permissible circle of confusion [mm]

For example, the lens microcomputer 111 obtains the position of the focus lens 105 (referred to as the deep focus position hereinafter) in which the imaging lens is in a deep focus state as a lens position according to the received hyperfocal length. The lens microcomputer 111 calculates a driving amount from the current position of the focus lens 105 to the deep focus position. The lens microcomputer 111 causes the focus control unit 109 to drive the focus lens 105 by the calculated driving amount. Thereby, the deep focus state is automatically set (deep focus setting is automatically made). A description will now be given of specific processing for deep focus control according to a first embodiment.

### First Embodiment

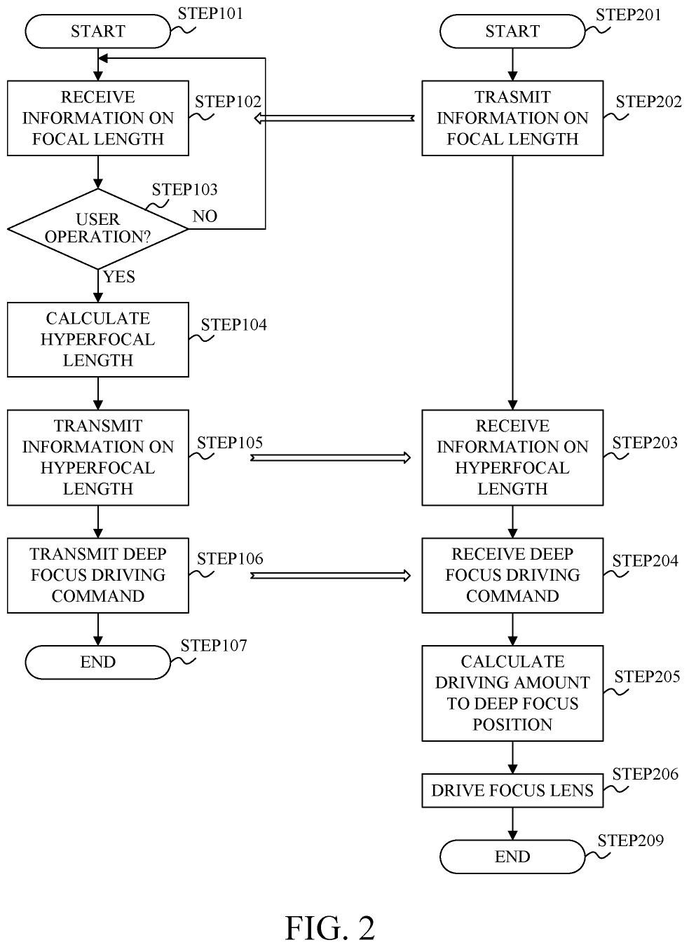

Flowcharts of FIG. 2 illustrate processing to be executed by the camera microcomputer 206 and the lens microcomputer 111 for the deep focus control in the first embodiment. The camera microcomputer 206 and the lens microcomputer 111 each execute this processing according to a computer program. The processing starting from Step 101 indicates processing to be executed by the camera microcomputer 206, and the processing starting from Step 201 indicates processing to be executed by the lens microcomputer 111. An arrow between the two flowcharts indicates a communication direction of information.

The camera microcomputer 206 that has started processing in Step 101 receives information on the current focal length of the imaging lens from the lens microcomputer 111 in Step 102. Information on the focal length will be described below. Since the focal length of the imaging lens changes depending on the operation of the zoom operation ring by the user, polling may be performed in a short cycle. In a case where polling is unavailable in a sufficiently short cycle, the order of Steps 102 and 103, which will be described below, may be changed.

In Step 103, the camera microcomputer 206 waits for an operation of the deep focus setting switch by the user. The flow returns to Step 102 if no operation is detected, and proceeds to Step 104 if the operation is detected.

In Step 104, the camera microcomputer 206 calculates (acquires) a hyperfocal length using a focal length derived from the information received from the lens microcomputer 111 in Step 102, an aperture value (F-number) set in imaging in the deep focus state (deep focus imaging), a diameter of a permissible circle of confusion (“PCOC”), and the expression (1). Alternatively, data on the hyperfocal length previously calculated by a combination of different focal lengths, aperture values, and POPC diameters may be stored as table data, and a corresponding hyperfocal length may be read out (acquired) from the data.

Next, in Step 105, the camera microcomputer 206 transmits the acquired information on the hyperfocal length to the lens microcomputer 111. The information on the hyperfocal length may be information indicating the hyperfocal length itself or information that is convertible into the hyperfocal length by the lens microcomputer 111, such as parameters (variables) of a function indicating the hyperfocal length.

Next, in Step 106, the camera microcomputer 206 transmits a deep focus driving command to the lens microcomputer 111. Then, the camera microcomputer 206 ends the processing in Step 107.

On the other hand, the lens microcomputer 111 that has started the processing in Step 201 obtains the current focal length of the imaging lens from the zoom position data obtained from the zoom position detecting unit 106 in Step 202, and transmits information on the focal length to the camera microcomputer 206. The information on the focal length may be information indicating the focal length itself or information such as the zoom position is convertible into the focal length by the camera microcomputer 206.

Next, in Step 203, the lens microcomputer 111 receives information on the hyperfocal length from the camera microcomputer 206. The lens microcomputer 111 receives the deep focus driving command from the camera microcomputer 206 in Step 204.

Next, in Step 205, the lens microcomputer 111 converts the hyperfocal length obtained from the information received in Step 203 into a deep focus position, and calculates a difference (driving amount) from the current position of the focus lens 105 to the deep focus position.

Next, in Step 206, the lens microcomputer 111 causes the focus control unit 109 to drive the focus lens 105 by the drive amount calculated in Step 205 to obtain a deep focus state. The lens microcomputer 111 ends the processing in Step 207.

This embodiment can easily provide deep focus imaging in a situation (at an arbitrary timing) intended by the user.

In this embodiment, the user can change the diameter of PCOC S. The diameter of PCOC δ is used as a parameter for calculating the hyperfocal length by the expression (1). An actual diameter of PCOC the maximum blur diameter that the viewer who views the captured image recognizes as a point having no blur. Assume that this blur diameter is an actual diameter of PCOC δ′. The actual diameter of PCOC δ′ depends on the viewing environment of the viewer and may not match the diameter of PCOC δ as a calculation parameter of the hyperfocal length. On the other hand, when the user can arbitrarily set (change) the diameter of PCOC δ assuming the viewing environment, deep focus imaging becomes available with the focus accuracy required (intended) by the user.

For example, in an assumption that the viewer views a captured image on a small screen (screen having a first size), a diameter of PCOC may be set that can provide deep focus imaging over a wide distance range (focus range) even if the focus accuracy is not so high. In addition, in an assumption that the viewer views a captured image on a large screen (screen having a second size), a diameter of PCOC may be set that can provide deep focus imaging highly accurately focused on an object within a narrow focus range.

The diameter of PCOC δ is set, for example, when the user selects one of selection menus that enable the user to select a plurality of imaging modes associated with different diameters of PCOC δ on the menu screen displayed on the display unit 204. In this case, the display unit 204 may be used as a setting unit in a case where the display unit 204 has a touch panel. The selection menu may be selected by the user operating a switch as a setting unit provided to the operation unit 205. The menu screen may be displayed on an external device (smartphone, tablet, etc.) that is communicable with the camera body 200, and the camera microcomputer 206 may be notified of the selection menu selected by the user on the external device as the setting unit in the camera body 200.

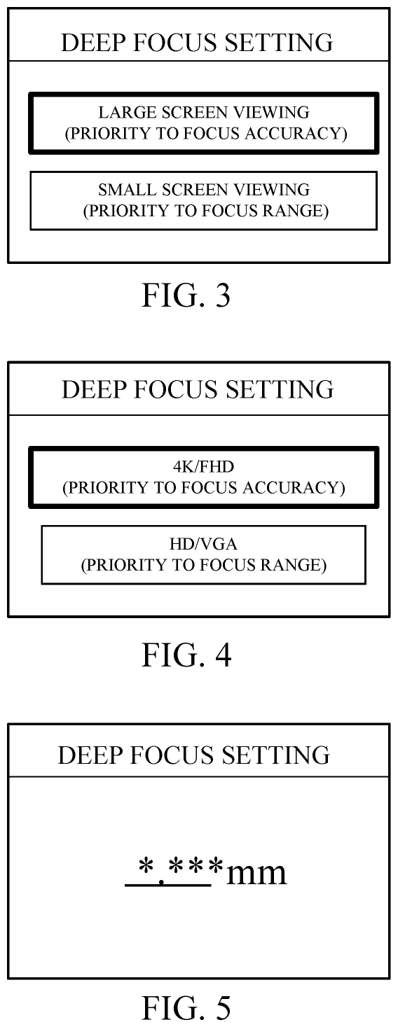

FIG. 3 illustrates an example of the menu screen (deep focus setting screen). The deep focus setting screen displays selection menus of a first imaging mode suitable for a “large screen viewing (priority to focus accuracy)” and a second imaging mode suitable for a “small screen viewing (priority to focus range).” The user selects one of the selection menus by a touch operation or the like.

A value “A” of the diameter of PCOC δ corresponding to the “large screen viewing (priority to focus accuracy)” and a value “B” of the diameter of PCOC δ corresponding to the “small screen viewing (priority to focus range)” are set so as to satisfy A<B.

The camera microcomputer 206 acquires (accepts) the value of the diameter of PCOC δ corresponding to the selection menu selected by the user in Step 104, and uses it to calculate the hyperfocal length.

This embodiment can easily provide deep focus imaging with the focus accuracy and focus range requested by the user in the lens interchangeable type image pickup system.

### Second Embodiment

Next, a second embodiment will be described. A deep focus setting screen illustrated in FIG. 4 displays selection menus illustrating imaging resolutions associated with diameters of PCOC δ different from each other. FIG. 4 displays selection menus of a plurality of moving image capturing modes associated with different permissible circle diameters S. More specifically, FIG. 4 displays selection menus of a first imaging mode for “4K/FHD (priority to focus accuracy)” imaging and a second imaging mode for “HD/VGA (priority to focus range)” imaging. The user selects one of the selection menus by a touch operation or the like.

In the moving image capturing, the imaging resolution may be selected according to the moving image viewing environment. For example, in viewing a moving image on a large screen, imaging is performed at a high resolution (first resolution) such as 4K (horizontal 3840×vertical 2160 pixels) or FHD (horizontal 1920×vertical 1080 pixels). On the other hand, in viewing a moving image on a small screen such as a smartphone, imaging is performed at a low resolution (second resolution) such as HD (horizontal 1280×vertical 720 pixels) or VGA (horizontal 854×vertical 480 pixels). In an assumption that the viewer views a captured image on a small screen, a diameter of PCOC may be set that can provide deep focus imaging over a wide distance range even if the focus accuracy is not so high. In an assumption that the viewer views a captured image on a large screen, a diameter of PCOC may be set that can provide deep focus imaging highly accurately focused on an object within a narrow distance range.

A value “C” of the diameter of PCOC δ corresponding to “4K/FHD (priority to focus accuracy)” and a value “D” of the diameter of PCOC δ corresponding to “HD/VGA (priority to focus range)” are set so as to satisfy C<D.

The camera microcomputer 206 uses the value of the diameter of PCOC δ corresponding to the selection menu selected by the user to calculate the hyperfocal length in Step 104 described above.

This embodiment can easily provide deep focus imaging with the focus accuracy and focus range requested by the user in the lens interchangeable type image pickup system.

### Third Embodiment

Next, a third embodiment will be described. A deep focus setting screen illustrated in FIG. 5 is a screen that enables the user to directly input the value of the diameter of PCOC S. This direct input of the value of the diameter of PCOC δ is effective for the user who knows a relationship among the diameter of PCOC, the hyperfocal length, and the distance range that provides a deep focus state.

Instead of the numerical input as illustrated in FIG. 5, the user may select one of a plurality of selection menus in which different values of the diameter of PCOC δ are displayed.

The camera microcomputer 206 uses the value of the diameter of PCOC δ input by the user in this way to calculate the hyperfocal length in Step 104 described above.

This embodiment may also easily provide deep focus imaging with the focus accuracy and focus range requested by the user in the interchangeable lens image pickup system.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-076984, filed on Apr. 30, 2021, which is hereby incorporated by reference herein in its entirety.

What is claimed is:

1. An image pickup apparatus attachable to and detachable from a lens apparatus, the image pickup apparatus comprising:
an image sensor;
at least one processor; and
at least one memory coupled to the at least one processor storing instructions that, when executed by the at least one processor, cause the at least one processor to function as:
an acquiring unit configured to acquire a hyperfocal length of the lens apparatus; and
a setting unit configured to enable a user to change a diameter of a permissible circle of confusion for acquiring the hyperfocal length.

2. The image pickup apparatus according to claim 1, wherein the setting unit enables the user to select one of a plurality of imaging modes each of which is associated with a different diameter of a permissible circle of confusion, and
wherein the acquiring unit acquires the hyperfocal length using the diameter of the permissible circle of confusion corresponding to a selected imaging mode.

3. The image pickup apparatus according to claim 2, wherein the plurality of imaging modes include a first imaging mode and a second imaging mode that has a focusable distance range wider than that the first imaging mode, and
wherein the diameter of the permissible circle of confusion corresponding to the second imaging mode is larger than that corresponding to the first imaging mode.

4. The image pickup apparatus according to claim 3, wherein the first imaging mode is an imaging mode for viewing a captured image on a screen having a first size, and
wherein the second imaging mode is an imaging mode for viewing the captured image on a screen having a second size smaller than the first size.

5. The image pickup apparatus according to claim 3, wherein the first imaging mode is an imaging mode for imaging at a first resolution, and
wherein the second imaging mode is an imaging mode for imaging at a second resolution lower than the first resolution.

6. The image pickup apparatus according to claim 2, wherein the setting unit displays the plurality of imaging modes so as to enable the user to select one of the imaging modes.

7. The image pickup apparatus according to claim 1, wherein the setting unit enables the user to input the diameter of the permissible circle of confusion.

8. The image pickup apparatus according to claim 1, wherein the image pickup apparatus is communicable with the lens apparatus, and
wherein the acquiring unit receives information on a focal length from the lens apparatus, and transmits information for driving a focus lens of the lens apparatus to a position corresponding to the hyperfocal length to the lens apparatus.

9. A lens apparatus attachable to, detachable from, and communicable with the image pickup apparatus according to claim 8, the lens apparatus comprising:
the focus lens; and
a lens control unit configured to drive the focus lens to a position corresponding to the hyperfocal length.

10. A control method of an image pickup apparatus attachable to and detachable from a lens apparatus and including an image sensor, the control method comprising the steps of:
acquiring a hyperfocal length of the lens apparatus; and
accepting a change by a user of a diameter of a permissible circle of confusion for acquiring the hyperfocal length.

11. A non-transitory computer-readable storage medium storing a program that causes a computer of an image pickup apparatus that includes an image sensor and is attachable to and detachable from a lens apparatus, to execute the control method according to claim 10.

12. A control apparatus comprising:
at least one processor; and
at least one memory coupled to the at least one processor storing instructions that, when executed by the at least one processor, cause the at least one processor to function as:
an acquiring unit configured to acquire a hyperfocal length of a lens apparatus attachable to and detachable from an image pickup apparatus; and
a setting unit configured to enable a user to change a diameter of a permissible circle of confusion for acquiring the hyperfocal length.

13. A control apparatus for an image pickup apparatus, the control apparatus comprising:
at least one processor; and
at least one memory coupled to the at least one processor storing instructions that, when executed by the at least one processor, cause the at least one processor to function as:
a selecting unit configured to enable a user to select a viewing condition of an image; and
a calculating unit configured to calculate a hyperfocal length of an imaging optical system.
